(19) United States
(12) Patent Application Publication
(10) Pub. No.: US 2006/0277152 A1
(43) Pub. Date: Dec. 7, 2006

(54) Estimate information creating device, estimate information creating and notifying method, and program-recorded medium

(76) Inventor: Shinji Hirotsune, Tenri-shi (JP)

Correspondence Address: EDWARDS & ANGELL, LLP, P.O. BOX 55874, BOSTON, MA, 02205, US

(21) Appl. No.: 10/554,758

(22) PCT Filed: Apr. 28, 2003
(86) PCT No.: PCT/JP03/05434

§ 371 Date: Oct. 27, 2005

(51) Int. Cl. G06Q 99/00; H04L 9/00; H04K 1/00

(52) U.S. Cl. 705/80

(57) ABSTRACT

In an estimate information creating device, an estimate newly-creating section (4) obtains a negotiation-independent information address of an updated negotiation-independent information from a negotiation-independent information DB (5), and further obtains, from a negotiation-dependent information DB (3), user information, user demand information, and an ID of negotiation-dependent information having the obtained negotiation-independent information address and having a “contract-unconcluded” status. An estimate creating section (2) returns to the estimate newly-creating section (4) estimate information that conforms to the user demand information, and the negotiation-independent information address. After estimate information identified by the obtained ID is updated, the estimate newly-creating section (4) sends notification to a user terminal (1). In such a way, an estimate is newly created when estimate basic information has changed.

### TECHNICAL FIELD

The present invention relates to an estimate information creating device and an estimate information creating and notifying method for creation of an estimate of a product and notification of the estimate or its announcement and also relates to a program-recorded medium containing an estimate creating and notifying program.

### BACKGROUND ART

In determining purchase of a product, a dealer may create an estimate in which the specifications and the price of the product are entered and a negotiating counterpart who is considering the purchase of the product may discuss the pros and cons of the purchase by using the estimate. The estimate is created on the basis of estimate basic information, or information such as cost and performances of components that serves as a basis for making an estimate. Then, if the estimate has contents that are not acceptable to the negotiating counterpart, the business negotiation will be unsuccessful and not reach a contract.

However, if the estimate basic information is updated and the contents of the estimate are changed by newly creating an estimate using the updated estimate basic information, there is a possibility (potential demand) that the negotiating counterpart considers it better to decide the purchase even if a contract will not concluded.

Therefore, as a method for making the potential demand reach the conclusion of a contract, there has been a business method by which with respect to the negotiation of which the estimate has been made but not reached the conclusion of a contract, a new estimate is presented to the same party to offer the restart of the negotiation when the estimate basic information is changed. The method is effective particularly for the negotiating counterpart who needs no immediate delivery of the product and postpones the purchase until the estimate of the product satisfies a certain requirement as well as for the sales of a product of which the price is gradually lowered or the performance is improved with time.

However, the conventional business method of newly creating an estimate and offering the restart of the negotiation has the problems as follows. That is, as a device to be used by the conventional business method, there is only a simple device that monitors the fall in the price of a certain product or a product that satisfies a certain specified requirement and notifies the negotiating counterpart of the fall in the price when the price has fallen below a certain price. Furthermore, it is rare that the notification is made by such a device in the case of a custom-made product and a system product for which a complicated estimation work is needed every negotiation.

The work of finding a negotiation having the potential to reach a contract if a new estimate is created and presented to the negotiating counterpart from among the negotiations that did not reach a contract in the past and newly creating an estimate, is complicated and necessitates a large amount of work in the case of custom-made products and system products. Therefore, the simple device, which notifies the negotiating counterpart of the price fall below a certain price as described above, cannot be used.

Particularly, in the case of a product that is manufactured by combining many kinds of components and that requires to be designed and estimated on the basis of the requirements of the negotiating counterpart every negotiation as in the case of a solar photovoltaic power generation device, it is complicated and requires a large amount of work to correctly investigate how the design change of a certain component exerts what kind of influence on the design of the solar photovoltaic power generation device and how the price and the performance consequently change. Moreover, when there is a subsidy system and the subsidy payment, the subsidy framework and the subsidy grant conditions sometimes change or in the case of a product of which the component prices may be largely varied, it is difficult to timely create a new estimate and inform the negotiating counterpart of the estimate because such work tends to concentrate in a certain period of time.

Therefore, it has conventionally been unable to carry out the business method without omission and with a small amount of labor for products like the solar photovoltaic power generation device, and business opportunities were often thrown away.

### SUMMARY OF THE INVENTION

It is an object of the present invention to provide an estimate information creating device and an estimate information creating and notifying method capable of newly creating and presenting an estimate when estimate basic information is changed, as well as providing a program-recorded medium containing an estimate information creating and notifying program.

In order to accomplish the above object, there is provided, according to a first aspect of the present invention, an estimate creating device for creating and notifying estimate information that includes a specification and/or an estimate of a price of a product, on the basis of user demand information that depends on a specific negotiation and estimate basic information that does not depend on any specific negotiation, comprising:

a negotiation-independent information database containing negotiation-independent information that includes the estimate basic information and an update flag indicating whether or not the estimate basic information has been updated;

an estimate creating section which, upon receiving an estimate create request, creates estimate information by obtaining from the negotiation-independent information database estimate basic information that conforms to user demand information and returns the created estimate information to a requestor of the estimate create request;

a negotiation-dependent information creating section which, upon receiving a request from a user terminal, transmits the estimate create request to the estimate creating section, creates negotiation-dependent information that includes the returned estimate information, contract conclusion information indicating whether or not a contract has been concluded concerning the product to which the estimate information is directed, and the user demand information, and issues the estimate information or an announcement that the estimate information has been created as a reply to the user terminal;

a negotiation-dependent information database in which the created negotiation-dependent information is stored;

a contract conclusion information updating section which, upon receiving updated contract conclusion information for updating a specific contract conclusion information piece, makes the negotiation-dependent information database update a contract conclusion information piece identified by the received updated contract conclusion information on the basis of the received updated contract conclusion information;

a negotiation-independent information updating section which, upon receiving update negotiation-independent information for updating a specific negotiation-independent information piece, makes the negotiation-independent information database update a negotiation-independent information piece identified by the received update negotiation-independent information on the basis of the received update negotiation-independent information; and

an estimate newly-creating section which, on the basis of information stored in the negotiation-independent information database and the negotiation-dependent information database, obtains negotiation-dependent information of which the contract has not yet been concluded and which includes estimate information created by using the estimate basic information that was an object of updating, transmits to the estimate creating section an estimate create request that includes user demand information of the obtained negotiation-dependent information, makes the negotiation-dependent information database update the negotiation-dependent information with returned estimate information, and transmits to the user terminal the estimate information or an announcement indicating that the estimate information has been created.

With the above construction, pieces of negotiation-independent information that include pieces of estimate basic information and associated update flags are stored in advance in the negotiation-independent information DB, and when update negotiation-independent information for updating a specific negotiation-independent information piece is inputted, the negotiation-independent information specified by the update negotiation-independent information is updated by the negotiation-independent information updating section. Then, the estimate newly-creating section requests the estimate creating section to create estimate information based on the user demand information in the negotiation-dependent information of which a contract has not been concluded and the estimate basic information in the negotiation-independent information updated. Thus, the estimate information newly created on the basis of the updated estimate basic information or an announcement regarding it is transmitted to the user terminal and presented to the negotiating counterpart.

Therefore, even in the case of custom-made products or system products manufactured by combining many kinds of components, i.e., products of which the estimate is changed by a change in the estimate basic information and the estimate must be made individually for each product such that conditions provided at each negotiation are satisfied, like solar photovoltaic power generation devices, the estimate information is automatically newly created on the basis of the updated estimate basic information just by registering in advance the negotiation-dependent information that includes the user demand information and the negotiation-independent information that includes the estimate basic information and using the update flag and the contract conclusion information.

Also, there is provided, according to a second aspect of the present invention, an estimate creating and notifying method for creating and notifying estimate information that includes a specification and/or an estimate of a price of a product, by using user demand information that depends on a specific negotiation and estimate basic information that does not depend on any specific negotiation, comprising steps:

storing negotiation-independent information including the estimate basic information in a negotiation-independent information database;

creating negotiation-dependent information including the user demand information;

creating the estimate information using the user demand information and the estimate basic information;

storing the created negotiation-dependent information in a negotiation-dependent information database when a contract has not been concluded concerning the product for which the estimate information is created;

updating the negotiation-independent information stored in the negotiation-independent information database;

newly creating estimate information when said step of updating the negotiation-independent information has been performed, based on the estimate basic information in the updated negotiation-independent information and the user demand information in the negotiation-dependent information stored in the negotiation-dependent information database; and

transmitting the estimate information as created or an announcement indicating that the estimate information has been created to a user associated with the user demand information.

With the above construction, the negotiation-dependent information that includes the user demand information is created and stored into the negotiation-dependent information DB only when a contract concerning the product is not concluded. When the negotiation-independent information stored in the negotiation-independent information DB is updated, estimate information is newly created on the basis of the updated estimate basic information and the user demand information stored in the negotiation-dependent information DB, and the newly created estimate information or a relevant announcement is presented to the user.

Therefore, even in the case of those custom-made products or system products in which the estimate must be made individually for each product such that conditions provided at each negotiation are satisfied, like solar photovoltaic power generation devices, the estimate information is automatically newly created on the basis of the updated estimate basic information just by registering in advance the negotiation-dependent information that includes the user demand information and the negotiation-independent information that includes the estimate basic information.

The negotiation-dependent information pieces stored in the negotiation-dependent information DB are unexceptionally negotiation-dependent information of which no contract has been concluded. Therefore, a labor for searching for unconcluded negotiation-dependent information pieces is saved in newly creating estimate information.

There is also provided, according to a third aspect of the invention, an estimate creating and notifying method for creating and notifying estimate information that includes a specification and/or an estimate of a price of a product, by using user demand information that depends on a specific negotiation and estimate basic information that does not depend on any specific negotiation, comprising steps:

storing negotiation-independent information including the estimate basic information in a negotiation-independent information database;

creating negotiation-dependent information including the user demand information and contract conclusion information indicating whether or not a contract has been concluded concerning the product for which the estimate information is created;

creating the estimate information using the user demand information and the estimate basic information;

storing the created negotiation-dependent information in a negotiation-dependent information database;

updating a content of the contract conclusion information in the negotiation-dependent information stored in the negotiation-dependent information database;

updating the negotiation-independent information stored in the negotiation-independent information database;

newly creating estimate information concerning the negotiation-dependent information for which the contract conclusion information stored in the negotiation-dependent information database indicates that no contract has been concluded, when said step of updating the negotiation-independent information has been performed, based on the estimate basic information in the updated negotiation-independent information and the user demand information in the negotiation-dependent information; and

transmitting the estimate information as created or an announcement indicating that the estimate information has been created to a user associated with the user demand information.

With the above construction, the negotiation-dependent information that includes the contract conclusion information and the user demand information is created and stored into the negotiation-dependent information DB. Moreover, the contract conclusion information of the product is updated. When the negotiation-independent information stored in the negotiation-independent information DB is updated, estimate information is newly created on the basis of the updated estimate basic information and the user demand information of the negotiation-dependent information, with respect to the negotiation-dependent information of which the contract conclusion information indicates no contract concluded, and the newly created estimate information or the relevant announcement is presented to the user.

Therefore, even in the case of those custom-made products or system products in which the estimate must be made individually for each product such that conditions provided at each negotiation are satisfied, like solar photovoltaic power generation devices, the estimate information is automatically newly created on the basis of the updated estimate basic information just by registering in advance the negotiation-dependent information that includes the user demand information and the negotiation-independent information that includes the estimate basic information.

The negotiation-dependent information DB contains all the pieces of negotiation-dependent information regardless of the conclusion or nonconclusion of a contract. Therefore, it becomes possible to carry out analysis of the negotiation, the negotiating counterpart or the like based on the negotiation-dependent information.

Furthermore, there is provided, according to a fourth aspect of the invention, an estimate creating and notifying method for creating and notifying estimate information that includes a specification and/or an estimate of a price of a product, by using user demand information that depends on a specific negotiation and estimate basic information that does not depend on any specific negotiation, comprising steps:

storing in a negotiation-independent information database negotiation-independent information including the estimate basic information and an update flag indicating whether or not the estimate basic information has been updated;

creating negotiation-dependent information including the user demand information;

creating the estimate information using the user demand information and the estimate basic information;

storing the created negotiation-dependent information in a negotiation-dependent information database;

updating the negotiation-independent information stored in the negotiation-independent information database and changing a content of the update flag such that the flag indicates updating has been performed;

newly creating estimate information referencing the content of the update flag and based on the estimate basic information in the updated negotiation-independent information and the user demand information in the negotiation-dependent information stored in the negotiation-dependent information database; and

transmitting the estimate information as created or an announcement indicating that the estimate information has been created to a user associated with the user demand information.

With the above construction, negotiation-dependent information including user demand information is created and stored into the negotiation-dependent information DB. On the other hand, negotiation-independent information that includes updated estimate basic information is created and stored into the negotiation-independent information DB. Moreover, the update flag for updated negotiation-independent information stored in the negotiation-independent information DB is set as updated. Then, estimate information is newly created referring to the content of the update flag and based on the updated estimate basic information of the negotiation-independent information and the user demand information stored in the negotiation-dependent information DB, and the newly created estimate information or the announcement regarding its creation is presented to the user.

Therefore, even in the case of those custom-made products or system products in which the estimate must be made individually for each product such that conditions provided at each negotiation are satisfied, like solar photovoltaic power generation devices, the estimate information is automatically newly created on the basis of the updated estimate basic information just by registering in advance the negotiation-dependent information that includes the user demand information and the negotiation-independent information that includes the estimate basic information.

In this case, the negotiation-independent information includes the update flag that indicates whether or not the estimate basic information has been updated. Therefore, it becomes possible to periodically execute the estimate information newly-creating process without limitation to immediately after the step of updating the negotiation-independent information is performed.

In one embodiment, the negotiation-dependent information includes user information that specifies a negotiating counterpart and/or a contact address of the negotiating counterpart, or a user information address that indicates a storage area of the user information, and information on a transmission destination of the estimate information or announcement used in the step of transmitting to the user associated with the user demand information is obtained on the basis of the user information or the user information address.

In this embodiment, the negotiation-dependent information includes the user information or the user information address that indicates the storage area of the user information. Therefore, the transmission destination of the estimate information or announcement is easily obtained.

In one embodiment, the negotiation-dependent information stored in the negotiation-dependent information database includes the estimate information and a negotiation-independent information address which is an address of the negotiation-independent information that includes the estimate basic information used in creating the estimate information, and the step of newly creating the estimate information comprises updating the estimate information in the negotiation-dependent information that includes the negotiation-independent information address for identifying the negotiation-independent information used in newly creating the estimate information, with the newly created estimate information.

In this embodiment, the negotiation-dependent information includes the estimate information and the negotiation-independent information address that specifies the negotiation-independent information used in creating the estimate information. Then, the stored estimate information is updated with newly created estimate information. During the process, the negotiation-dependent information that includes the estimate information to be updated is easily found on the basis of the negotiation-independent information address that is the address of the negotiation-independent information used in creating the update estimate information.

In one embodiment, the method according to any one of the second to fourth aspects of the invention further comprises transmitting the created estimate information to a user terminal for presentation to the negotiating counterpart in response to a request from the negotiating counterpart via the user terminal.

In this embodiment, when a request for the estimate is received from a user, the created estimate information is automatically transmitted to the user terminal.

In one embodiment, the method according to the third or fourth aspect of the invention further comprises obtaining a plurality of pieces of the negotiation-dependent information stored in the negotiation-dependent information database and carrying out analysis concerning the negotiation or assistance to the analysis on the basis of the obtained negotiation-dependent information.

In this embodiment, the analysis concerning the negotiation or the analysis assistance is automatically carried out based on the plurality of pieces of negotiation-dependent information stored in the negotiation-dependent information DB.

In one embodiment of the method according to the fourth aspect of the invention, the step of newly creating the estimate information is periodically executed.

In this embodiment, updated estimate basic information is automatically retrieved periodically so that estimate information is newly created. Therefore, if the step of transmitting to the user associated with the user demand information is concurrently carried out, the user is periodically and automatically notified of the newly created estimate information or the announcement.

In one embodiment of the method according to any one of the second to fourth aspects of the invention, the product for negotiation is a solar photovoltaic power generation device.

Therefore, even in solar photovoltaic power generation devices, which are custom-made products or system products manufactured by combining many kinds of components and of which the estimate must be made individually for each product such that conditions provided at each negotiation are satisfied, the estimate information is automatically newly created on the basis of the updated estimate basic information and notified to the corresponding user, or negotiating counterpart, just by registering in advance the negotiation-dependent information that includes the user demand information and the negotiation-independent information that includes the estimate basic information.

In one embodiment, the user demand information includes at least one of roof information concerning a roof on which a solar battery is installed, a desired power output, a desired time of purchase, solar battery installation surface conditions, and a desired purchase price.

In one embodiment, the estimate information includes at least one of information concerning layout design for solar battery installation at individual customers' houses, and a subsidy application time or a new product release time.

In one embodiment, the estimate basic information includes at least one of information concerning installation, information concerning a subsidy, and information concerning a solar battery module or information concerning a power controller.

A program-recorded medium according to a fifth aspect of the present invention contains an estimate creating and notifying program, which program makes a computer function as the estimate creating section, the negotiation-dependent information creating section, the contract conclusion information updating section, the negotiation-independent information updating section, and the estimate newly-creating section of the first aspect of the invention.

With the above construction, similar to the first aspect of the present invention, even in the case of custom-made products or system products manufactured by combining many kinds of components, i.e., products of which the estimate is changed by a change in the estimate basic information and the estimate must be made individually for each product such that conditions provided at each negotiation are satisfied, like solar photovoltaic power generation devices for example, the estimate information is automatically newly created on the basis of the updated estimate basic information just by registering in advance the negotiation-dependent information that includes the user demand information and the negotiation-independent information that includes the estimate basic information and using the update flag and the contract conclusion information.

### BRIEF DESCRIPTION OF THE DRAWINGS

FIG. 1 is a schematic block diagram of an estimate information creating device of the present invention;

FIG. 2 is a chart showing principal information stored in a negotiation-dependent information DB and a negotiation-independent information DB in FIG. 1;

FIG. 3 is a flow chart of a negotiation-dependent information creating operation;

FIG. 4 is a flow chart of an estimate basic information obtaining operation executed in the negotiation-dependent information creating operation shown in FIG. 3;

FIG. 5 is a flow chart of a negotiation analyzing operation;

FIG. 6 is a flow chart of a contract conclusion information updating operation;

FIG. 7 is a flow chart of a negotiation-independent information updating operation;

FIG. 8 is a flow chart of an estimate newly-creating operation;

FIG. 9 is a flow chart of the estimate newly-creating operation continued from FIG. 8; and

FIG. 10 is a flow chart of an estimate inquiring operation.

### DETAILED DESCRIPTION OF THE INVENTION

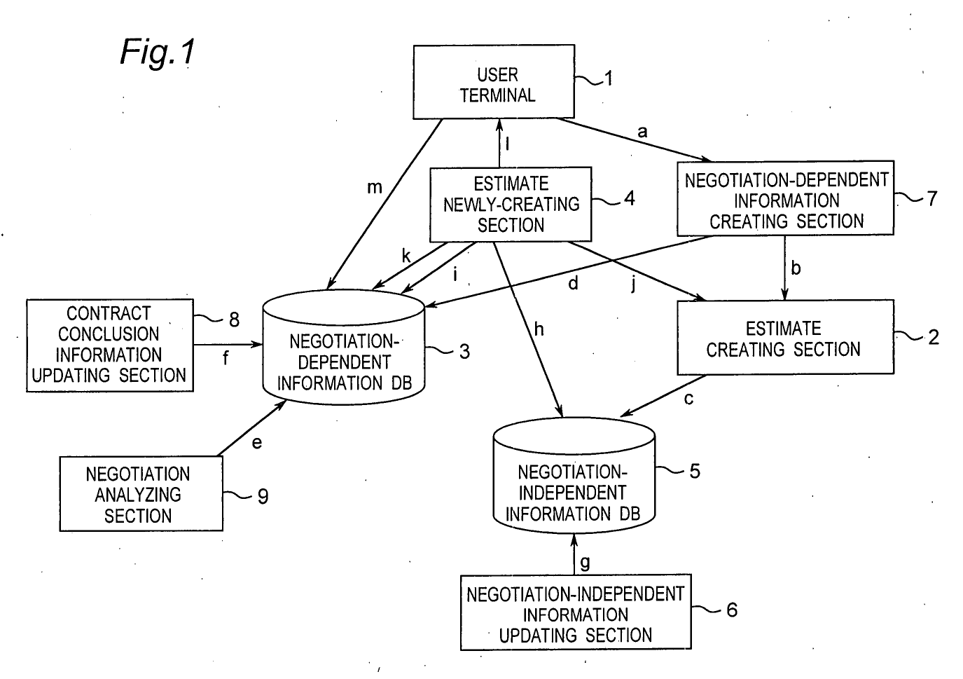

Embodiments of the present invention will now be described with reference to the accompanying drawings. FIG. 1 is a schematic block diagram of the estimate information creating device of the present embodiment.

The present estimate information creating device has a user terminal 1, an estimate creating section 2, a negotiation-dependent information DB 3, an estimate newly-creating section 4, a negotiation-independent information DB 5, a negotiation-independent information updating section 6, a negotiation-dependent information creating section 7, a contract conclusion information updating section 8 and a negotiation analyzing section 9.

The arrows in FIG. 1 indicate the relations between clients and servers. The originating sides of the arrows are the clients, and the destination sides are the servers, indicating that the clients transmit requests to the servers, and the servers execute operations corresponding to the requests. That is, the arrows in FIG. 1 indicate the directions in which the requests are transmitted. It is noted, however, that the arrows may indicate a series of operations in which not only a request is issued, but also after a processing is performed, a result of the processing is returned to a client and the client receives the return.

Moreover, the negotiation-dependent information DB 3 and the negotiation-independent information DB 5 are databases in which information, including the estimate basic information, about products, commercial transactions, users, past negotiation results and so on is stored. The “database” in the present embodiment means one that stores one or more records of information described in a predetermined format. Further, a new record is stored according to an external request, and an ID (index) of the stored record is generated. Furthermore, the database retrieves a record or records that conform to conditions included in the external request, process the conforming record(s) through updating, deletion or format conversion, if necessary, according to the request, and supply the record(s) to the requestor. An existing concrete example of the database is an SQL server.

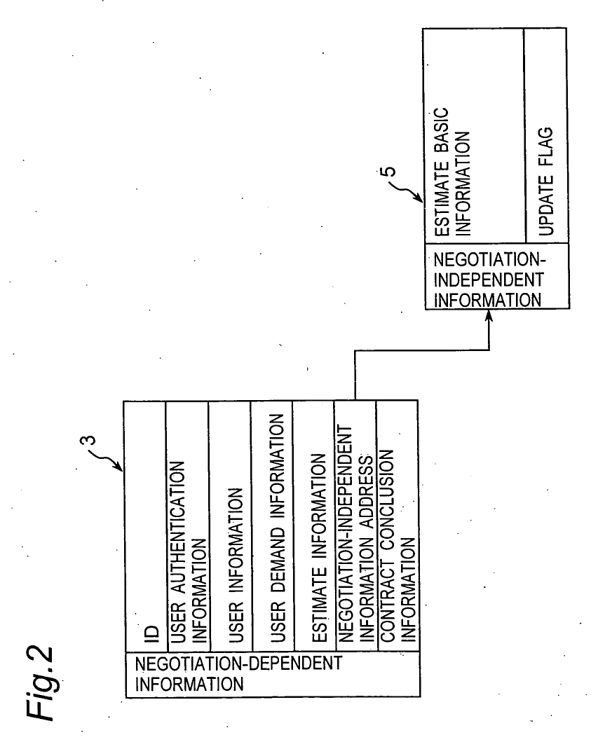

FIG. 2 shows principal information pieces stored in the negotiation-dependent information DB 3 and the negotiation-independent information DB 5, which are the databases used in the present embodiment. In the following description, it is assumed that information having no ID, i.e., in the state before storage in the negotiation-dependent information DB 3 is also referred to as the “negotiation-dependent information”. The contents of the information will be described below with reference to FIG. 2.

A plurality of pieces of negotiation-dependent information are stored as a record in the negotiation-dependent information DB3. The negotiation-dependent information is a combination of ID, user authentication information, user information, user demand information, estimate information, negotiation-independent information addresses including zero, and contract conclusion information, with one combination assigned to one negotiation. The pieces of information will be described below.

The ID is the information that identifies a record (i.e., a piece of negotiation-dependent information).

The user authentication information is the information that authenticates a negotiating counterpart and specifically, a password, a fingerprint image and the like may be used.

The user information is the information that specifies the negotiating counterpart or the user terminal 1, such as the ZIP code, address, name, telephone number, mail address. It is acceptable to add information that specifies a sales company, such as the ZIP code, address, name of a person in charge, telephone number, mail address and the like of the sales company.

The user demand information is the information that represents items desired by the negotiating counterpart. When the product of the negotiation is a solar photovoltaic power generation device for home use, the information may include demands in the situation of purchase regarding roof information, a desired power output, a desired time of purchase, installation surface conditions (facing only the south, both the south and the east, both the south and the west, etc.), purchase conditions (such as the price and/or the degree of output at which the purchase is wished) and so on. It is noted that the roof information is the information regarding the roof on which a solar battery is to be installed, such as the age of the house, azimuth, roof outside dimensions, roof material, roof slope, roof slope, roof shape (gable roof, hip roof, flat roof, etc.), planar dimensions immediately below the roof, eaves projection, verge projection and so on.

The estimate information is the information concerning the design (specifications) and/or the estimate of a price of the product of negotiation. When the product of negotiation is a solar photovoltaic power generation device for home use, the estimate information is information concerning the layout design of a customer's house, such as the layout plan, outside drawing, structural component list, prices of the components, and so on. Further, it is acceptable to add information about the subsidy application time, the new product release time and so on.

The negotiation-independent information address is an address of negotiation-independent information at the negotiation-independent information DB 5 in which the estimate basic information used for creating the estimate information is stored.

The contract conclusion information is the information that indicates whether or not a contract of manufacturing, sales, lease, and/or supply of the product of negotiation has been “concluded”.

A plurality of pieces of negotiation-independent information are stored as a record in the negotiation-independent information DB 5. The negotiation-independent information is constituted of estimate basic information and an update flag.

The estimate basic information is information that is used for creating the estimate information and does not depend on a specific negotiation. When the product of negotiation is a solar photovoltaic power generation device for home use, the estimate basic information consists of at least one of installation information, subsidy information and module information.

The installation information contains the installation-related prices, dimensions and/or information. The prices are of the structural components such as face decorative panels, dummy panels, splicing fittings, bolts and so on, which are classified by installation methods according to roof materials and constructions. The dimensions are dimensions of the structural components, and the information contains a charge for installation work, a charge for electric work, and so on.

The subsidy information is the information concerning the subsidy, such as the conditions, payment, application time and so on of the subsidy system of a government and/or a municipality.

The module information is information concerning the solar battery modules, such as the shape, dimensions, output, and price or information concerning power control, such as an input voltage range, the number of input systems, and output power. Moreover, it is acceptable to add information concerning other optional products that exert influences on the layout design.

The update flag is information that indicates whether or not the estimate basic information of the negotiation-independent information has been updated, and expresses “truth” or “false”.

The estimate information creating device having the above construction operates as follows to carry out the creation and notification of estimate information. The estimate information creating and notifying method has a procedure constituted o a negotiation-dependent information creating process, a negotiation analyzing process, a contract conclusion information updating process, a negotiation-independent information updating process, an estimate newly-creating process and an estimate inquiring process. The processes are independent processes of which the execution is started by different events. The processes will be described in order in detail.

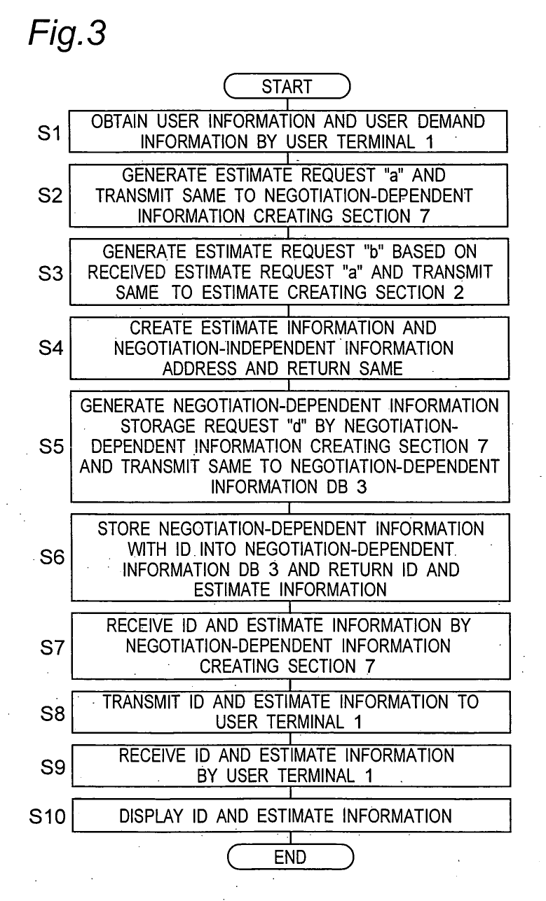

The negotiation-dependent information creating process is a process for obtaining user information and user demand information by the user terminal 1, creating negotiation-dependent information including the user information and the user demand information, and displaying and/or outputting an ID that specifies the negotiation-dependent information and the estimate information created by using the user demand information. FIG. 3 is a flow chart showing the operation of the negotiation-dependent information creating process. The procedure of the negotiation-dependent information creating process will be described below with reference to FIG. 3. The negotiation-dependent information creating operation starts when user information and user demand information are externally inputted to the user terminal 1.

In step S1, the user terminal 1 obtains inputted user information and user demand information. In step S2, an estimate request “a” that contains the user information and the user demand information is generated by the user terminal 1 and transmitted to the negotiation-dependent information creating section 7. In step S3, the estimate request “a” from the user terminal 1 is received by the negotiation-dependent information creating section 7. Then, an estimate request “b” that includes the user demand information obtained from the estimate request “a” is generated and transmitted to the estimate creating section 2. In step S4, the estimate request “b” from the negotiation-dependent information creating section 7 is received by the estimate creating section 2. Then, estimate information is created by using the user demand information obtained from the estimate request “b”. Then, the created estimate information and a negotiation-independent information address of the negotiation-independent information including the estimate basic information used in forming the estimate information are returned to the negotiation-dependent information creating section 7 that is the sender of the estimate request “b”.

In step S5, negotiation-dependent information that includes the user information, the user demand information, the estimate information and the negotiation-independent information address is created by the negotiation-dependent information creating section 7, and a negotiation-dependent information storage request “d” that includes the created negotiation-dependent information is transmitted to the negotiation-dependent information DB 3. In step S6, the negotiation-dependent information storage request “d” from the negotiation-dependent information creating section 7 is received by the negotiation-dependent information DB 3. Then, the negotiation-dependent information obtained from the negotiation-dependent information storage request d is stored along with an associated ID. Moreover, the ID and the estimate information are returned to the negotiation-dependent information creating section 7.

In step S7, the ID and the estimate information as a reply to the negotiation-dependent information storage request “d” are received by the negotiation-dependent information creating section 7. In step S8, the ID and the estimate information are transmitted to the user terminal 1 by the negotiation-dependent information creating section 7 as a reply to the estimate request “a”. In step S9, the ID and the estimate information of the reply to the estimate request “a” are received by the user terminal 1. In step S10, the received ID and estimate information are displayed or outputted by the user terminal 1. Thereafter, the negotiation-dependent information creating operation ends.

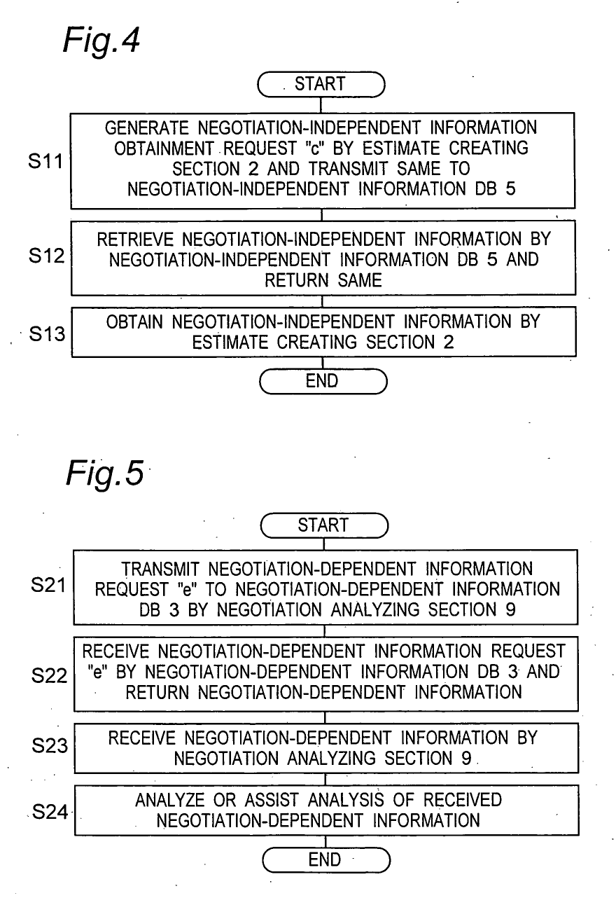

The following will describe in detail an estimate basic information obtainment subroutine for obtaining the estimate basic information used when the estimate creating section 2 creates the estimate information and the negotiation-independent information address in step S4 of the negotiation-dependent information creating operation shown in FIG. 3. FIG. 4 is a flow chart of the estimate basic information obtaining operation. The estimate basic information obtaining operation starts when the estimate creating section 2 receives the estimate request “b” from the negotiation-dependent information creating section 7 in step S4 of the negotiation-dependent information creating operation shown in FIG. 3.

In step S11, a negotiation-independent information obtainment request “c” is generated by the estimate creating section 2 and transmitted to the negotiation-independent information DB 5. In step S12, the negotiation-independent information obtainment request “c” is received by the negotiation-independent information DB 5. Then, the negotiation-independent information requested by the negotiation-independent information obtainment request “c” is retrieved and supplied to the estimate creating section 2 as a reply. In step S13, the negotiation-independent information from the negotiation-independent information DB 5 is received by the estimate creating section 2. When the negotiation-independent information that includes the estimate basic information is thus obtained by the estimate creating section 2, the estimate basic information obtaining operation ends.

Subsequently, as described above, on the basis of the estimate basic information included in the received negotiation-independent information and the user demand information included in the estimate request “b” from the negotiation-dependent information creating section 7, the estimate creating section 2 creates estimate information that conforms to the user demand information and the negotiation-independent information address of the negotiation-independent information that includes the estimate basic information used in creating the estimate information.

As described above, when the user information and the user demand information are inputted to the user terminal 1, the user terminal 1 transmits the estimate request that includes the user demand information to the estimate creating section 2 via the negotiation-dependent information creating section 7. Then, the estimate creating section 2 creates and returns to the negotiation-dependent information creating section 7 estimate information and a negotiation-independent information address of the then used estimate basic information. Then, the negotiation-dependent information creating section 7 generates negotiation-dependent information that includes the user information, the user demand information, the estimate information and the negotiation-independent information address, and transmits the negotiation-dependent information storage request “d” to the negotiation-dependent information DB 3 to make it store the negotiation-dependent information with the corresponding negotiation-dependent information ID. Then, the negotiation-dependent information creating section 7 sends the ID and the estimate information returned from the negotiation-dependent information DB 3 to the user terminal 1.

That is, according to the present embodiment, only by inputting the user information and the user demand information to the user terminal 1, estimate information that conforms to the user demand information can be automatically created and outputted to the user terminal 1. Therefore, even in the case of the custom-made product or the system product manufactured by combining many kinds of components like the solar photovoltaic power generation device, the estimate information is easily created and displayed only by registering in advance the estimate basic information that does not depend on a specific negotiation. Further, the negotiation-dependent information that includes the created estimate information is automatically registered in the negotiation-dependent information DB 3.

The negotiation analyzing process will be described next. The negotiation analyzing process is a process for analyzing the negotiation and/or the negotiating counterpart by a statistical method or assisting the analysis on the basis of a plurality of pieces of negotiation-dependent information stored in the negotiation-dependent information DB 3. FIG. 5 is a flow chart showing the operation of the negotiation analyzing process. The procedure of the negotiation analyzing process will be described next with reference to FIG. 5. The negotiation analyzing operation starts when an event directed to the negotiation analyzing section 9 occurs.

In step S21, a negotiation-dependent information request “e” is generated by the negotiation analyzing section 9 and transmitted to the negotiation-dependent information DB 3. In step S22, the negotiation-dependent information request “e” is received by the negotiation-dependent information DB 3, which then returns to the negotiation analyzing section 9 a stored negotiation-dependent information piece requested by the negotiation-dependent information request “e”. In step S23, the negotiation-dependent information that is the reply to the negotiation-dependent information request “e” is received by the negotiation analyzing section 9. In step S24, the analysis by a statistical method or the assistance to the analysis of the contents of the negotiation and/or the negotiating counterpart is carried out on the basis of the received negotiation-dependent information. Thereafter, the negotiation analyzing operation ends. It is to be noted that the contents of the analysis of the negotiation-dependent information and the analyzing method therefor have no direct relation to the present invention, and therefore, no detailed description thereof is provided.

As described above, when an event directed to the negotiation analyzing section 9 occurs, the negotiation analyzing section 9 transmits the negotiation-dependent information request “e” to the negotiation-dependent information DB 3. Then, the negotiation analyzing section 9 analyzes negotiation-dependent information returned from the negotiation-dependent information DB 3. Otherwise, the assistance to the analysis is carried out. Therefore, the analysis or the assistance to the analysis of the negotiation-dependent information stored in the negotiation-dependent information DB 3 is automatically and easily carried out.

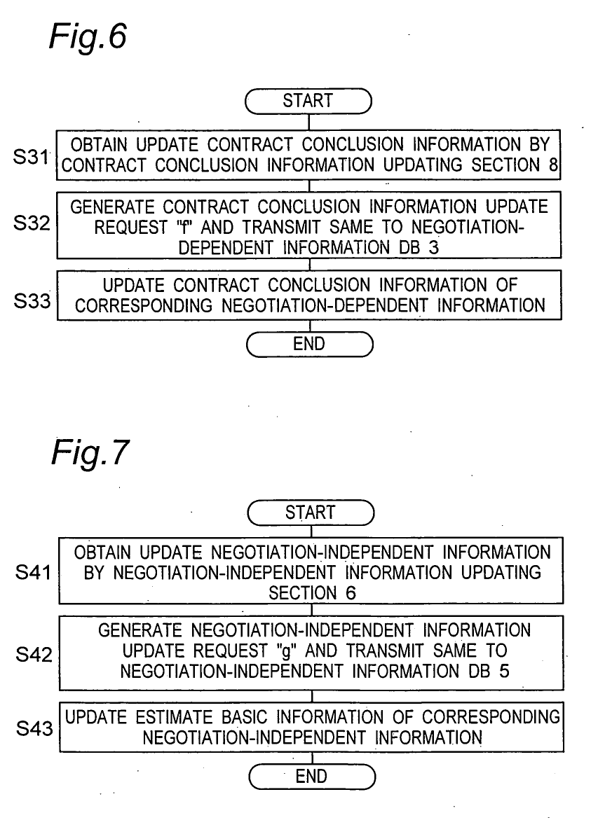

The contract conclusion information updating process will be described next. The contract conclusion information updating process is a process for obtaining update contract conclusion information by the contract conclusion information updating section 8 and updating the contract conclusion information included in the negotiation-dependent information on the basis of the obtained update contract conclusion information. The “update contract conclusion information” is the information for updating specific contract conclusion information. FIG. 6 is a flow chart showing the operation of the contract conclusion information updating process. The procedure of the contract conclusion information updating process will be described below with reference to FIG. 6. The contract conclusion information updating operation starts when update contract conclusion information is inputted from the outside to the contract conclusion information updating section 8.

In step S31, the inputted update contract conclusion information is obtained by the contract conclusion information updating section 8. In step S32, a contract conclusion information update request “f” that includes the update contract conclusion information is generated by the contract conclusion information updating section 8 and transmitted to the negotiation-dependent information DB 3. In step S33, the contract conclusion information update request “f” is received by the negotiation-dependent information DB 3. Then, the content of the contract conclusion information included in the corresponding negotiation-dependent information is updated on the basis of the update contract conclusion information contained in the contract conclusion information update request “f”. Thereafter, the contract conclusion information updating operation ends.

As described above, when a contract of the manufacturing, sales, lease and/or supply of a product is concluded as a result of negotiation, the update contract conclusion information is inputted to the contract conclusion information updating section 8. Then, the contract conclusion information updating section 8 transmits to the negotiation-dependent information DB 3 a contract conclusion information update request “f” containing the update contract conclusion information so as to update the contract conclusion information of the negotiation-dependent information corresponding to the content of the concluded contract as “concluded”. Therefore, only by inputting the update contract conclusion information to the contract conclusion information updating section 8, the contract conclusion information of the negotiation-dependent information DB 3 is automatically and easily updated.

The negotiation-independent information updating process will be described next. The negotiation-independent information updating process is a process for obtaining update negotiation-independent information by the negotiation-independent information updating section 6 and updating the negotiation-independent information stored in the negotiation-independent information DB 5 on the basis of the update negotiation-independent information. The “update negotiation-independent information” is the information for updating specific negotiation-independent information. FIG. 7 is a flow chart showing the operation of the negotiation-independent information updating process. The procedure of the negotiation-independent information updating process will be described below with reference to FIG. 7. The negotiation-independent information updating operation starts when update negotiation-independent information is inputted from the outside to the negotiation-independent information updating section 6.

In step S41, the inputted update negotiation-independent information is obtained by the negotiation-independent information updating section 6. In step S42, a negotiation-independent information update request “g” that includes the update negotiation-independent information is generated by the negotiation-independent information updating section 6 and transmitted to the negotiation-independent information DB 5. In step S43, the negotiation-independent information update request “g” is received by the negotiation-independent information DB 5. Then, the contents of the estimate basic information of the corresponding negotiation-independent information are updated on the basis of the update negotiation-independent information of the negotiation-independent information update request “g”, and the content of the associated update flag is updated to “true (updated)”. Thereafter, the negotiation-independent information updating operation ends.

As described above, when a change occurs in the negotiation-independent information that does not depend on a specific negotiation like installation information, subsidy information and module information in the case of the solar photovoltaic power generation device for home use, the update negotiation-independent information is inputted to the negotiation-independent information updating section 6. Then, the negotiation-independent information updating section 6 transmits the negotiation-independent information update request “g” that includes the update negotiation-independent information to the negotiation-independent information DB 5 to update the estimate basic information of the corresponding negotiation-independent information and update the update flag of the negotiation-independent information to “true”. Therefore, only by inputting the update negotiation-independent information to the negotiation-independent information updating section 6, the estimate basic information and the associated update flag in the negotiation-independent information DB 5 is automatically and easily updated.

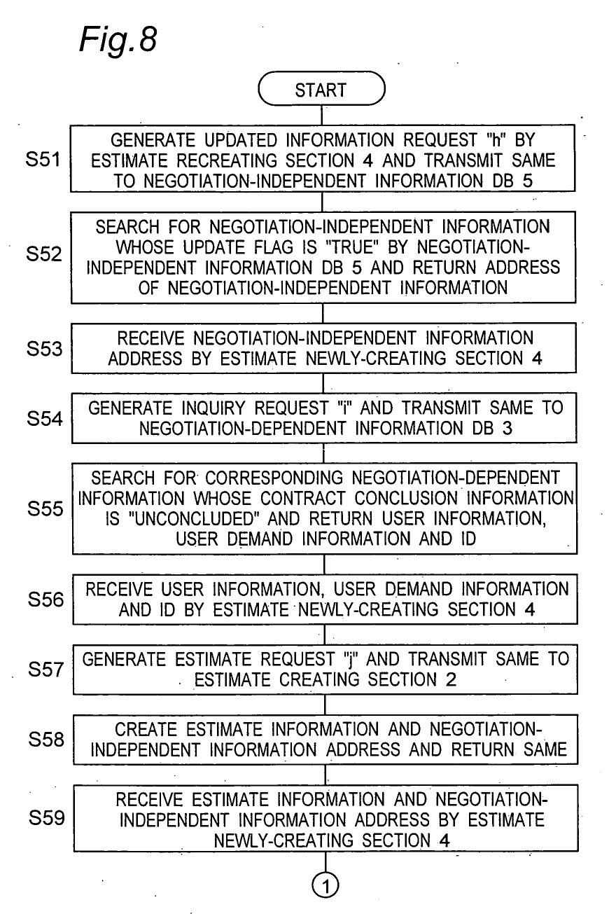

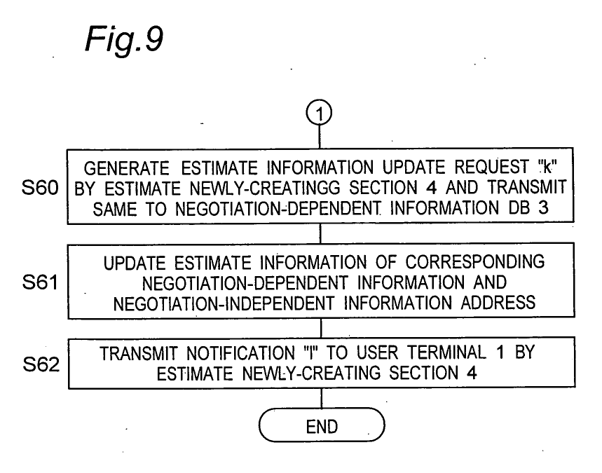

The estimate newly-creating process will be described next. In the estimate newly-creating process, estimate information included in negotiation-dependent information in an unconcluded state is updated by using estimate basic information updated in the negotiation-independent information updating process and the updated estimate information is notified to the user terminal 1 or the customer on the basis of the user information of the negotiation-dependent information. It is to be noted that the estimate newly-creating process is a process to be periodically executed by the estimate newly-creating section 4. FIGS. 8 and 9 are flow charts showing the operation of the estimate newly-creating process. The procedure of the estimate newly-creating process will be described below with reference to FIGS. 8 and 9. The estimate newly-creating operation starts when an event directed to the estimate newly-creating section 4 occurs.

In step S51, an updated information request “h” is generated by the estimate newly-creating section 4 and transmitted to the negotiation-independent information DB 5. In step S52, the updated information request “h” is received by the negotiation-independent information DB 5. Then, the negotiation-independent information of which the content of the update flag is “true (updated)” is retrieved, and the address of the retrieved negotiation-independent information is returned to the estimate newly-creating section 4. In step S53, the negotiation-independent information address sent in reply to the updated information request “h” is received by the estimate newly-creating section 4. In step S54, an inquiry request “i” that includes the negotiation-independent information address is generated by the estimate newly-creating section 4 and transmitted to the negotiation-dependent information DB 3.

In step S55, the inquiry request “i” is received by the negotiation-dependent information DB 3. Then, negotiation-dependent information, of which the content of the negotiation-independent information address indicates the address of the negotiation-independent information included in the inquiry request “i” and the content of the contract conclusion information is “unconcluded”, is retrieved. The user information, user demand information and ID included in the retrieved negotiation-dependent information are returned to the estimate newly-creating section 4. In step S56, the user information, user demand information and ID as the reply to the inquiry request “i” are received by the estimate newly-creating section 4. In step S57, an estimate request “j” that includes the received user demand information is generated by the estimate newly-creating section 4 and transmitted to the estimate creating section 2.

In step S58, estimate information and a negotiation-independent information address concerning the negotiation-independent information that includes the estimate basic information used in creating the estimate information are newly created by using the user demand information in the estimate request “j” by the estimate creating section 2. Then, the created estimate information and negotiation-independent information address are returned to the estimate newly-creating section 4. In step S59, the estimate information and the negotiation-independent information address as a reply to the estimate request “j” are received by the estimate newly-creating section 4. In step S60, an estimate information update request “k”, which includes the ID received as the reply to the inquiry request “i” and the estimate information and negotiation-independent information address received as the reply to the estimate request “j”, is generated by the estimate newly-creating section 4 and transmitted to the negotiation-dependent information DB 3.

In step S61, the estimate information update request “k” is received by the negotiation-dependent information DB 3. Then, the estimate information and the negotiation-independent information address of negotiation-dependent information identified by the ID of the estimate information update request “k” are updated with the value of the estimate information and the value of the negotiation-independent information address in the estimate information update request “k”. The reason why the value of the negotiation-independent information address is updated is that the estimate basic information used in newly creating estimate information may differ from the estimate basic information used in initially creating the estimate information due to the updating of the estimate basic information. In step S62, a notification “l” directed to the negotiating counterpart is transmitted from the estimate newly-creating section 4 to a user terminal 1 identified by the user information received as a reply to the inquiry request “i”. The notification “l” is a message (announcement) notifying the fact that the estimate information has been updated. Subsequently, the estimate newly-creating operation ends. Then, the notification “l” is received by the user terminal 1 and displayed or outputted.

As described above, when an event directed to the estimate newly-creating section 4 occurs, the estimate newly-creating section 4 obtains the negotiation-independent information address of the updated negotiation-independent information from the negotiation-independent information DB 5. Further, the estimate newly-creating section 4 obtains, from the negotiation-dependent information DB 3, the user information, user demand information and ID of negotiation-dependent information having the obtained negotiation-independent information address and having the “unconcluded” status. Then, the estimate newly-creating section 4 transmits to the estimate creating section 2 the estimate request “j” that includes the obtained user demand information.

Then, the estimate creating section 2 creates estimate information that conforms to the user demand information. Then, the estimate creating section 2 returns the estimate information and the negotiation-independent information address of the negotiation-independent information that includes the estimate basic information used in creating the estimate information to the estimate newly-creating section 4. The estimate newly-creating section 4 transmits the estimate information update request “k” that includes the obtained ID, estimate information and negotiation-independent information address to the negotiation-dependent information DB 3 to update the estimate information and the negotiation-independent information address of the negotiation-dependent information identified by the ID. Then, the notification “l” announcing the estimate information having been updated is transmitted to the user terminal 1.

Thus, finding out the “unconcluded” user information and user demand information concerning the updated negotiation-independent information, newly creating the estimate information intended for the identified user to update the negotiation-dependent information DB 3, and transmitting the estimate information update announcement to the user are automatically performed.

That is, according to the present embodiment, even in the case of custom-made products or system products manufactured by combining many kinds of components, i.e., products of which the estimate is changed by a change in the estimate basic information and the estimate must be made individually for each product such that conditions provided at each negotiation are satisfied, like solar photovoltaic power generation devices for example, the estimate information can easily be newly created only by registering the estimate basic information in advance and providing an update flag that indicates whether or not the estimate basic information has been updated and contract conclusion information that indicates whether or not the contract concerning the product of negotiation has been concluded.

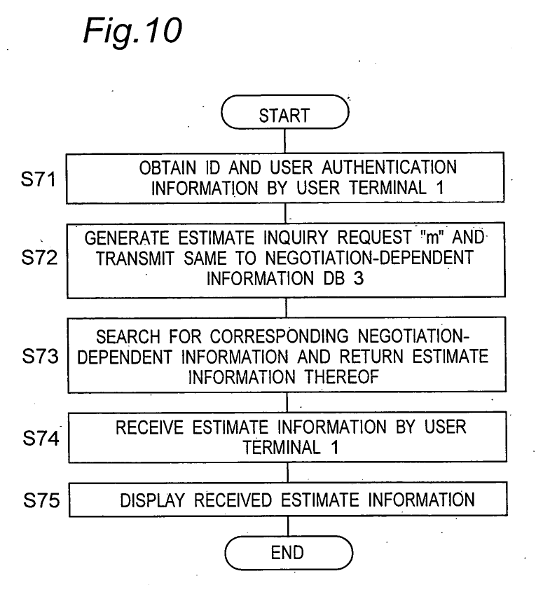

The estimate inquiring process will be described next. The estimate inquiring process is a process for obtaining the ID and user authentication information by the user terminal 1 and displaying and/or outputting the estimate information of negotiation-dependent information identified by the ID and authenticated by the user authentication information. In general, a customer who has received the notification “l” starts the process in order to obtain the updated estimate information. FIG. 10 is a flow chart showing the operation of the estimate inquiring process. The procedure of the estimate inquiring process will be described below with reference to FIG. 10. When an ID and user authentication information are inputted to the user terminal 1, the estimate inquiring operation starts.

In step S71, the ID and user authentication information are obtained by the user terminal 1. In step S72, an estimate inquiry request “m” that includes the ID and the user authentication information is generated by the user terminal 1 and transmitted to the negotiation-dependent information DB 3. In step S73, the estimate inquiry request “m” is received by the negotiation-dependent information DB 3. Then, negotiation-dependent information that conforms to the ID and the user authentication information of the estimate inquiry request “m” is searched for and retrieved, and the thus obtained estimate information is issued as a reply. In step S74, the estimate information is received as the reply to the estimate inquiry request “m” by the user terminal 1. In step S75, the received estimate information is displayed and/or outputted by the user terminal 1. Subsequently, the estimate inquiring operation ends.

As described above, when the ID and the user authentication information are inputted to the user terminal 1, the user terminal 1 outputs the estimate inquiry request “m” to the negotiation-dependent information DB 3, to make the latter supply the estimate information of negotiation-dependent information that conforms to the ID and the user authentication information. Then, the user terminal 1 displays and/or outputs the obtained estimate information. Therefore, with the provision of the estimate newly-creating section 4, the estimate information newly created on the basis of the updated estimate basic information is automatically obtained and outputted.

The estimate information creating device of the present embodiment carries out the creation of estimate information and notification by properly combining the negotiation-dependent information creating process, the negotiation analyzing process, the contract conclusion information updating process, the negotiation-independent information updating process, the estimate newly-creating process and the estimate inquiring process.

Actual algorithms of the processes are not limited to those shown in the flow charts of FIGS. 3 through 10. Moreover, it is acceptable to add other pieces of information to the negotiation-dependent information DB 3 and the negotiation-independent information DB 5.

In the described embodiment, the contract conclusion information is included in the negotiation-dependent information, and the negotiation-dependent information created in the negotiation-dependent information creating process is unconditionally stored into the negotiation-dependent information DB 3. However, the present invention is not limited to this, and it is acceptable to eliminate the contract conclusion information from the negotiation-dependent information and store negotiation-dependent information created in the negotiation-dependent information creating process into the negotiation-dependent information DB in the negotiation-dependent information storing process only when no contract has been concluded with an estimate created in the estimate creating process on the basis of that negotiation-dependent information.

In that case, all the negotiation-dependent information stored in the negotiation-dependent information DB is unexceptionally negotiation-dependent information of which no contract has been concluded. Therefore, a labor for searching for unconcluded negotiation-dependent information by the negotiation-dependent information DB is saved in newly creating estimate information.

Moreover, in the described embodiment, the update flag is included in the negotiation-independent information, and the negotiation-independent information address of the updated negotiation-independent information is obtained by referring to the content of the update flag in the estimate newly-creating process. However, the present invention is not limited to this, and it is also acceptable to eliminate the update flag and immediately after executing the negotiation-independent information updating process, obtain the negotiation-independent information address of the negotiation-independent information (updated negotiation-independent information).

In that case, a labor for referring to the update flag in the estimate newly-creating process is saved.

Moreover, in the described embodiment, the user information is included in the negotiation-dependent information. Then, information that specifies the negotiating counterpart, the user terminal 1 or the sales company is used as the user information. However, the present invention is not limited to this, and it is acceptable to store the user information that specifies the negotiating counterpart, the user terminal 1 and/or the sales company in an area independent from the negotiation-dependent information and include in the negotiation-dependent information a user information address that indicates the storage area of the user information.

It is to be noted that the functions of the estimate creating section 2, the negotiation-dependent information creating section 7, the contract conclusion information updating section 8, the negotiation-independent information updating section 6, and the estimate newly-creating section 4 of the described embodiment are achieved by an estimate creating and notifying program recorded in a program recording medium. The computer-readable recording medium may be a program medium constructed of a ROM (Read Only Memory). Otherwise, it may be a program medium that is to be loaded in an external auxiliary storage device and read thereby. In either case, a program reading means for reading the estimate creating and notifying program from the program medium may be configured to make direct access to the program medium or to load the program into a program storage area provided in a RAM (Random Access Memory) and make access to the program storage area. It is noted that a download program used for downloading from the program medium into the program storage area of the RAM is stored in advance in a main unit.

The “program medium” herein is a medium that is constituted separable from the main unit and stationarily carries a program, inclusive of tapes such as magnetic tapes, cassette tapes and so on, magnetic disks such as flexible disks, hard disks and so on, optical disks such as CD-ROM (Compact Disc-Read Only Memory), MO (Magnet Optical disk), MD (Mini Disc), DVD (Digital Versatile Disc) and so on, cards such as IC (Integrated Circuit) cards, optical cards and so on, and semiconductor memories such as mask ROM, EPROM (Erasable Programmable Read Only Memory: ultraviolet erasable ROM), EEPROM (Electronically Erasable Programmable Read Only Memory: electrically erasable ROM), flash ROM and so on.

Moreover, the estimate information creating device of the embodiment can have a construction that includes a modem, a LAN card or the like and is connectable to a communication network including the Internet. In such a case, the program medium may be a medium that fluidly carries a program by downloading it from the communication network or the like. In such a case, a download program for the download from the communication network in the case is stored in advance in the main unit or installed from another recording medium.

The matter to be recorded in the recording medium is not limited only to the program, but data is also recordable.

1. canceled

2. canceled

3. canceled

4. canceled

5. canceled

6. canceled

7. canceled

8. canceled

9. canceled

10. canceled

11. canceled

12. canceled

13. canceled

14. canceled

15. An estimate creating device for creating and notifying estimate information that includes a specification and/or an estimate of a price of a product, on the basis of user demand information that depends on a specific negotiation and estimate basic information that does not depend on any specific negotiation, comprising:
a negotiation-independent information database containing negotiation-independent information that includes the estimate basic information and an update flag indicating whether or not the estimate basic information has been updated;
an estimate creating section which, upon receiving an estimate create request, creates estimate information by obtaining from the negotiation-independent information database estimate basic information that conforms to user demand information and returns the created estimate information to a requester of the estimate create request;
a negotiation-dependent information creating section which, upon receiving a request from a user terminal, transmits the estimate create request to the estimate creating section, creates negotiation-dependent information that includes the returned estimate information, contract conclusion information indicating whether or not a contract has been concluded concerning the product to which the estimate information is directed, and the user demand information, and issues the estimate information or an announcement that the estimate information has been created as a reply to the user terminal;
a negotiation-dependent information database in which the created negotiation-dependent information is stored;
a contract conclusion information updating section which, upon receiving updated contract conclusion information for updating a specific contract conclusion information piece, makes the negotiation-dependent information database update a contract conclusion information piece identified by the received updated contract conclusion information on the basis of the received updated contract conclusion information;
a negotiation-independent information updating section which, upon receiving updated negotiation-independent information for updating a specific negotiation-independent information piece, makes the negotiation-independent information database update a negotiation-independent information piece identified by the received updated negotiation-independent information on the basis of the received updated negotiation-independent information; and
an estimate newly-creating section which, on the basis of information stored in the negotiation-independent information database and the negotiation-dependent information database, obtains negotiation-dependent information when the contract has not yet been concluded which includes estimate information created by using the estimate basic information that was an object of updating, transmits to the estimate creating section an estimate create request that includes user demand information of the obtained negotiation-dependent information, makes the negotiation-dependent information database update the negotiation-dependent information with returned estimate information, and transmits to the user terminal the estimate information or an announcement indicating that the estimate information has been created.

16. A computer-readable program-recorded medium that contains an estimate creating and notifying program, wherein said program makes a computer function as:
the estimate creating section, the negotiation-dependent information creating section, the contract conclusion information updating section, the negotiation-independent information updating section, and the estimate newly-creating section as set forth in claim 15.

17. An estimate creating and notifying method for creating and notifying estimate information that includes a specification and/or an estimate of a price of a product, by using user demand information that depends on a specific negotiation and estimate basic information that does not depend on any specific negotiation, comprising the steps of:
storing negotiation-independent information including the estimate basic information in a negotiation-independent information database;
creating negotiation-dependent information including the user demand information;
creating the estimate information using the user demand information and the estimate basic information;
storing the created negotiation-dependent information in a negotiation-dependent information database when a contract has not been concluded concerning the product for which the estimate information is created;
updating the negotiation-independent information stored in the negotiation-independent information database;
newly creating estimate information when said step of updating the negotiation-independent information has been performed, based on the estimate basic information in the updated negotiation-independent information and the user demand information in the negotiation-dependent information stored in the negotiation-dependent information database; and
transmitting the estimate information as created or an announcement indicating that the estimate information has been created to a user associated with the user demand information.

18. The estimate information creating and notifying method as set forth in claim 17, wherein
the negotiation-dependent information includes user information that specifies a negotiating counterpart and/or a contact address of the negotiating counterpart, or a user information address that indicates a storage area of the user information, and
information on a transmission destination of the estimate information or announcement used in the step of transmitting to the user associated with the user demand information is obtained on the basis of the user information or the user information address.

19. The estimate information creating and notifying method as set forth in claim 17, wherein
the negotiation-dependent information stored in the negotiation-dependent information database includes the estimate information and a negotiation-independent information address which is an address of the negotiation-independent information that includes the estimate basic information used in creating the estimate information, and
the step of newly creating the estimate information comprises updating the estimate information in the negotiation-dependent information that includes the negotiation-independent information address for identifying the negotiation-independent information used in newly creating the estimate information, with the newly created estimate information.

20. The estimate information creating and notifying method as set forth in claim 17, comprising the step of:
transmitting the created estimate information to a user terminal for presentation to the negotiating counterpart in response to a request from the negotiating counterpart via the user terminal.

21. The estimate information creating and notifying method as set forth in claim 17, wherein
the product for negotiation is a solar photovoltaic power generation device.

22. The estimate information creating and notifying method as set forth in claim 21, wherein
the user demand information includes at least one of roof information concerning a roof on which a solar battery is to be installed, a desired power output, a desired time of purchase, solar battery installation surface conditions, and a desired purchase price.

23. The estimate information creating and notifying method as set forth in claim 21, wherein
the estimate information includes at least one of:
information concerning layout design for solar battery installation at individual customers' houses; and
a subsidy application time or a new product release time.

24. The estimate information creating and notifying method as set forth in claim 21, wherein
the estimate basic information includes at least a subsidy application time or a new product one of:
information concerning installation;
information concerning a subsidy; and
information concerning a solar battery module or information concerning a power controller.

25. An estimate creating and notifying method for creating and notifying estimate information that includes a specification and/or an estimate of a price of a product, by using user demand information that depends on a specific negotiation and estimate basic information that does not depend on any specific negotiation, comprising the steps of:
storing negotiation-independent information including the estimate basic information in a negotiation-independent information database;
creating negotiation-dependent information including the user demand information and contract conclusion information indicating whether or not a contract has been concluded concerning the product for which the estimate information is created;
creating the estimate information using the user demand information and the estimate basic information;
storing the created negotiation-dependent information in a negotiation-dependent information database;
updating a content of the contract conclusion information in the negotiation-dependent information stored in the negotiation-dependent information database;
updating the negotiation-independent information stored in the negotiation-independent information database;
newly creating estimate information concerning the negotiation-dependent information for which the contract conclusion information stored in the negotiation-dependent information database indicates that no contract has been concluded, when said step of updating the negotiation-independent information has been performed, based on the estimate basic information in the updated negotiation-independent information and the user demand information in the negotiation-dependent information; and
transmitting the estimate information as created or an announcement indicating that the estimate information has been created to a user associated with the user demand information.

26. The estimate information creating and notifying method as set forth in claim 25, wherein
the negotiation-dependent information includes user information that specifies a negotiating counterpart and/or a contact address of the negotiating counterpart, or a user information address that indicates a storage area of the user information, and
information on a transmission destination of the estimate information or announcement used in the step of transmitting to the user associated with the user demand information is obtained on the basis of the user information or the user information address.

27. The estimate information creating and notifying method as set forth in claim 25, wherein
the negotiation-dependent information stored in the negotiation-dependent information database includes the estimate information and a negotiation-independent information address which is an address of the negotiation-independent information that includes the estimate basic information used in creating the estimate information, and
the step of newly creating the estimate information comprises updating the estimate information in the negotiation-dependent information that includes the negotiation-independent information address for identifying the negotiation-independent information used in newly creating the estimate information, with the newly created estimate information.

28. The estimate information creating and notifying method as set forth in claim 25, comprising the step of:
transmitting the created estimate information to a user terminal for presentation to the negotiating counterpart in response to a request from the negotiating counterpart via the user terminal.

29. The estimate information creating and notifying method as set forth in claim 25, comprising the step of:
obtaining a plurality of pieces of the negotiation-dependent information stored in the negotiation-dependent information database and carrying out an analysis concerning the negotiation or assistance to an analysis concerning the negotiation on the basis of the obtained negotiation-dependent information.

30. The estimate information creating and notifying method as set forth in claim 25, wherein
the product for negotiation is a solar photovoltaic power generation device.

31. The estimate information creating and notifying method as set forth in claim 30, wherein
the user demand information includes at least one of roof information concerning a roof on which a solar battery is to be installed, a desired power output, a desired time of purchase, solar battery installation surface conditions, and a desired purchase price.

32. The estimate information creating and notifying method as set forth in claim 30, wherein
the estimate information includes at least one of:
information concerning layout design for solar battery installation at individual customers' houses; and
a subsidy application time or a new product release time.

33. The estimate information creating and notifying method as set forth in claim 30, wherein
the estimate basic information includes at least one of:
information concerning installation;
information concerning a subsidy; and
information concerning a solar battery module or information concerning a power controller.

34. An estimate creating and notifying method for creating and notifying estimate information that includes a specification and/or an estimate of a price of a product, by using user demand information that depends on a specific negotiation and estimate basic information that does not depend on any specific negotiation, comprising the steps of:
storing in a negotiation-independent information database negotiation-independent information including the estimate basic information and an update flag indicating whether or not the estimate basic information has been updated;
creating negotiation-dependent information including the user demand information;
creating the estimate information using the user demand information and the estimate basic information;
storing the created negotiation-dependent information in a negotiation-dependent information database;
updating the negotiation-independent information stored in the negotiation-independent information database and changing a content of the update flag such that the flag indicates updating has been performed;
newly creating estimate information referencing the content of the update flag and based on the estimate basic information in the updated negotiation-independent information and the user demand information in the negotiation-dependent information stored in the negotiation-dependent information database; and
transmitting the estimate information as created or an announcement indicating that the estimate information has been created to a user associated with the user demand information.

35. The estimate information creating and notifying method as set forth in claim 34, wherein
the negotiation-dependent information includes user information that specifies a negotiating counterpart and/or a contact address of the negotiating counterpart, or a user information address that indicates a storage area of the user information, and
information on a transmission destination of the estimate information or announcement used in the step of transmitting to the user associated with the user demand information is obtained on the basis of the user information or the user information address.

36. The estimate information creating and notifying method as set forth in claim 34, wherein
the negotiation-dependent information stored in the negotiation-dependent information database includes the estimate information and a negotiation-independent information address which is an address of the negotiation-independent information that includes the estimate basic information used in creating the estimate information, and
the step of newly creating the estimate information comprises updating the estimate information in the negotiation-dependent information that includes the negotiation-independent information address for identifying the negotiation-independent information used in newly creating the estimate information, with the newly created estimate information.

37. The estimate information creating and notifying method as set forth in claim 34, comprising the step of:
transmitting the created estimate information to a user terminal for presentation to the negotiating counterpart in response to a request from the negotiating counterpart via the user terminal.

38. The estimate information creating and notifying method as set forth in claim 34 comprising the step of:
obtaining a plurality of pieces of the negotiation-dependent information stored in the negotiation-dependent information database and carrying out an analysis concerning the negotiation or assistance to an analysis concerning the negotiation on the basis of the obtained negotiation-dependent information.

39. The estimate information creating and notifying method as set forth in claim 34, wherein
the step of newly creating the estimate information is periodically executed.

40. The estimate information creating and notifying method as set forth in claim 34, wherein the product for negotiation is a solar photovoltaic power generation device.

41. The estimate information creating and notifying method as set forth in claim 40, wherein
the user demand information includes at least one of roof information concerning a roof on which a solar battery is to be installed, a desired power output, a desired time of purchase, solar battery installation surface conditions, and a desired purchase price.

42. The estimate information creating and notifying method as set forth in claim 40, wherein
the estimate information includes at least one of:
information concerning layout design for solar battery installation at individual customers' houses; and
a subsidy application time or a new product release time.

43. The estimate information creating and notifying method as set forth in claim 40, wherein
the estimate basic information includes at least one of:
information concerning installation;
information concerning a subsidy; and
information concerning a solar battery module or information concerning a power controller.
